(19) United States
(12) Patent Application Publication
(10) Pub. No.: US 2016/0300138 A1
(43) Pub. Date: Oct. 13, 2016

(54) METHOD AND SYSTEM FOR CONTEXT-BASED INTENT VERIFICATION

(71) Applicant: Doat Media Ltd., Tel Aviv (IL)

(72) Inventor: Dvir VOLK, Tel Aviv (IL)

(73) Assignee: Doat Media Ltd., TEL AVIV (IL)

(21) Appl. No.: 15/180,549

(22) Filed: Jun. 13, 2016

Related U.S. Application Data
(63) Continuation-in-part of application No. 14/955,831, filed on Dec. 1, 2015.
Application No. 14/955,831 is a continuation-in-part of application No. 14/850,200, filed on Sep. 10, 2015.
Application No. 14/850,200 is a continuation of application No. 13/712,563, filed on Dec. 12, 2012, now Pat. No. 9,141,702.
Application No. 13/712,563 is a continuation-in-part of application No. 13/156,999, filed on Jun. 9, 2011, now Pat. No. 9,323,844.
Application No. 13/712,563 is a continuation-in-part of application No. 13/296,619, filed on Nov. 15, 2011.
Application No. 14/955,831 is a continuation-in-part of application No. 14/583,310, filed on Dec. 26, 2014.
Application No. 14/583,310 is a continuation-in-part of application No. 13/712,563, filed on Dec. 12, 2012, now Pat. No. 9,141,702.
(60) Provisional application No. 62/175,335, filed on Jun. 14, 2015.
(60) Provisional application No. 62/086,728, filed on Dec. 3, 2014.
(60) Provisional application No. 61/468,095, filed on Mar. 28, 2011.
(60) Provisional application No. 61/354,022, filed on Jun. 11, 2010.
(60) Provisional application No. 61/920,784, filed on Dec. 26, 2013.

(51) Int. Cl. G06N 5/02; G06Q 30/02; H04L 29/08

(52) U.S. Cl. CPC G06N 5/022; H04L 67/22; G06Q 30/0251

(57) ABSTRACT

A server and method for contextual verification of a user intent. The method includes: determining, based on at least one variable related to a user device, a user intent; determining, based on the user intent, at least one contextual assumption; determining, based on the at least one contextual assumption, at least one expected variable; determining whether the at least one expected variable has been identified with respect to the user device; and determining the user intent as verified, when the at least one expected variable has been identified.

### CROSS-REFERENCE TO RELATED APPLICATIONS

This application claims the benefit of U.S. Provisional Application No. 62/175,335 filed on Jun. 14, 2015. This application is also a continuation-in-part of U.S. patent application Ser. No. 14/955,831 filed on Dec. 1, 2015, now pending, which claims the benefit of U.S. Provisional Application No. 62/086,728 filed on Dec. 3, 2014. The Ser. No. 14/955,831 Application is a continuation-in-part of:

(a) U.S. patent application. Ser. No. 14/850,200 filed on Sep. 10, 2015 which is a continuation of U.S. patent application Ser. No. 13/712,563 filed on Dec. 12, 2012, now U.S. Pat. No. 9,141,702. The Ser. No. 13/712,563 Application is a continuation-in-part of: (I) U.S. patent application Ser. No. 13/156,999 filed on Jun. 9, 2011, now U.S. Pat. No. 9,323,844, which claims the benefit of U.S. Provisional Patent Application No. 61/468,095 filed on Mar. 28, 2011, and U.S. Provisional Patent Application No. 61/354,022, filed on Jun. 11, 2010; and (II) U.S. patent application Ser. No. 13/296,619 filed on Nov. 15, 2011, now pending.

(b) U.S. patent application Ser. No. 14/583,310 filed on Dec. 26, 2014, now pending. The Ser. No. 14/583,310 Application claims the benefit of U.S. Provisional Patent Application No. 61/920,784 filed on Dec. 26, 2013. The Ser. No. 14/583,310 Application is also a continuation-in-part of the above-mentioned Ser. No. 13/712,563 Application.

The contents of the above-referenced applications are hereby incorporated by reference.

### TECHNICAL FIELD

The present disclosure relates generally to determining user intents based on context, and more specifically to verifying such user intents.

### BACKGROUND

The use of mobile devices such as smart phones, mobile phones, tablet computers, and other similar devices, has significantly increased in past years. Mobile devices allow access to a variety of application programs also known as “applications” or “apps.” The applications are usually designed to help a user of a mobile device to perform a specific task. Applications may be bundled with the computer and its system software, or may be accessible, and sometimes downloadable, from a central repository.

Through the central repositories, users can download applications for virtually any purpose, limited only by the amount of memory available on the users' phones. Applications exist for social media, finance, news, entertainment, gaming, and more. Some applications serve multiple purposes or otherwise offer multiple types of content.

Because of the widespread and often inexpensive availability of these applications, users typically have multiple applications on their mobile device which they infrequently use. For example, a user may download an application for finding his or her car based on GPS and a starting position, but may only use the car-finding application a few times a year. In contrast, a user may download a news application and use the news application at least once every day.

Additionally, applications with multiple features typically offer functions and content the users infrequently use. As an example, a fantasy football application may provide both football-related news and the ability to set a fantasy football “lineup,” but the user may primarily only use the lineup feature.

These applications also frequently allow advertisers to display advertisements while the applications are open. For advertisers advertising through these applications, knowing which applications (or portions thereof) that are being used more frequently is incredibly important for obtaining maximum exposure of their advertisements to users. Pre-determination of the applications a user intends to use at certain times is therefore valuable at least for advertising purposes within such applications. Any further assurances regarding the accuracy of such user intents provide additional value.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Some embodiments disclosed herein include a method for contextual verification of a user intent. The method includes: determining, based on at least one variable related to a user device, a user intent; determining, based on the user intent, at least one contextual assumption; determining, based on the at least one contextual assumption, at least one expected variable; determining whether the at least one expected variable has been identified with respect to the user device; and determining the user intent as verified, when the at least one expected variable has been identified.

Some embodiments disclosed herein also include a server for contextual verification of a user intent. The server includes a processing system; and a memory, the memory containing instructions that, when executed by the processing system, configure the server to: determining, based on at least one variable related to a user device, a user intent; determining, based on the user intent, at least one contextual assumption; determining, based on the at least one contextual assumption, at least one expected variable; determining whether the at least one expected variable has been identified with respect to the user device; and determining the user intent as verified, when the at least one expected variable has been identified

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of an intent detector according to an embodiment.

FIG. 3 is a flow diagram illustrating generating insights for determining user intent according to an embodiment.

FIG. 4 is a flowchart illustrating a method for verifying a user intent according to an embodiment.

FIG. 5 is a flowchart illustrating a method for determining a user intent according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for contextually verifying user intents. Variables associated with a user of a user device are analyzed. Based on the analysis, contextual assumptions related to user intent are determined. Expected variables are determined based on the determined contextual assumptions. The contextual assumptions are validated by checking whether the expected variables are identified. Based on the validation, it is determined whether the user intent is verified.

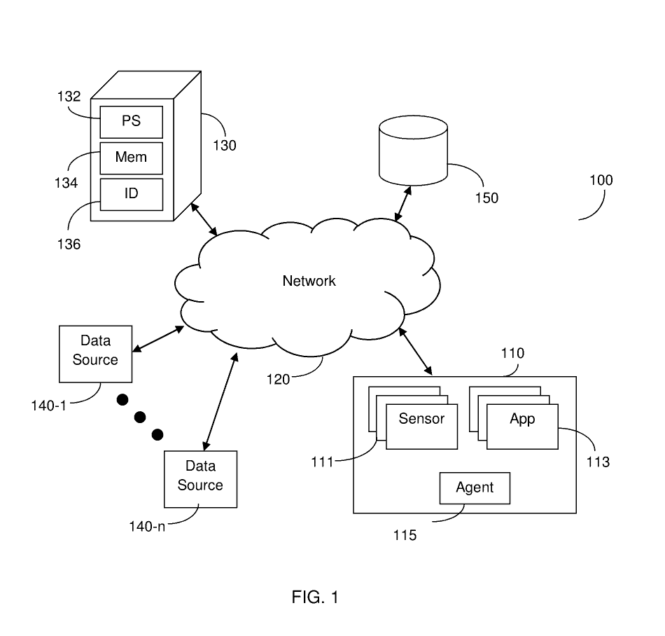

FIG. 1 shows an example network diagram 100 utilized to describe the various disclosed embodiments. The network diagram 100 includes a user device 110, a network 120, a server 130, and a plurality of data sources 140-1 through 140-n (hereinafter referred to individually as a data source 140 and collectively as data source 140, merely for simplicity purposes). In some embodiments, the network diagram 100 further includes a database 150. In some embodiments, the database 150 includes a plurality of contexts and corresponding insights utilized to determine contextual scenarios.

The user device 110 may be, but is not limited to, a smart phone, a mobile phone, a laptop, a tablet computer, a wearable computing device, a personal computer (PC), a smart television, and the like. The network 120 may be, but is not limited to, a local area network (LAN), a wide area network (WAN), a metro area network (MAN), the world wide web (WWW), the Internet, a wired network, a wireless network, similar networks, and the like, as well as any combination thereof. Each of the data sources 140 may be, but is not limited to, a web search engine, a server of a content provider, a vertical comparison engine, a server of a content publisher, and the like.

The user device 110 may execute or have installed therein, but is not limited to, one or more sensors 111, one or more applications (apps) 113, and an agent 115. The sensors 111 may be, but are not limited to, a microphone, a clock, a global positioning system, a camera, and the like. The applications 113 executed or accessed through the client device 110 may include, but are not limited to, a mobile application, a virtual application, a web application, a native application, and the like. The agent 115 may be an application installed on the user device 110 for collecting data related to user intent and to send such data to, e.g., the server 130.

To this end, the user device 110 is configured to collect variables associated with a user of the user device 110. The collected variables may be, but are not limited to, environmental variables, personal variables, queries, or a combination thereof. Environmental variables are typically based on and represent signals over which users have no direct control such as, for example, time of day, location, motion information, weather information, sounds, images, and so on. Personal variables are typically based on and represent signals over which users have direct control such as, for example, applications executed on the user device 110, actions taken by the user device 110, and so on. The queries may be, but are not limited to, queries provided to the user device 110 (e.g., textual queries, selection of a button associated with a query, etc.). The signals may be collected by the user device 110 using one or more of the sensors 111.

The collected variables may be sent by the user device 110 to the server 130 over the network 120. In an embodiment, the server 130 includes an intent detector utilized to generate insights into user intents. The server 130 is configured to determine a user intent via the intent detector 136 based on the collected variables. The user intent represents the type of content, the content, actions, or a combination thereof that may be of interest to a user during a current time period. For example, for a current time period in the morning, a user intent may be to read news articles.

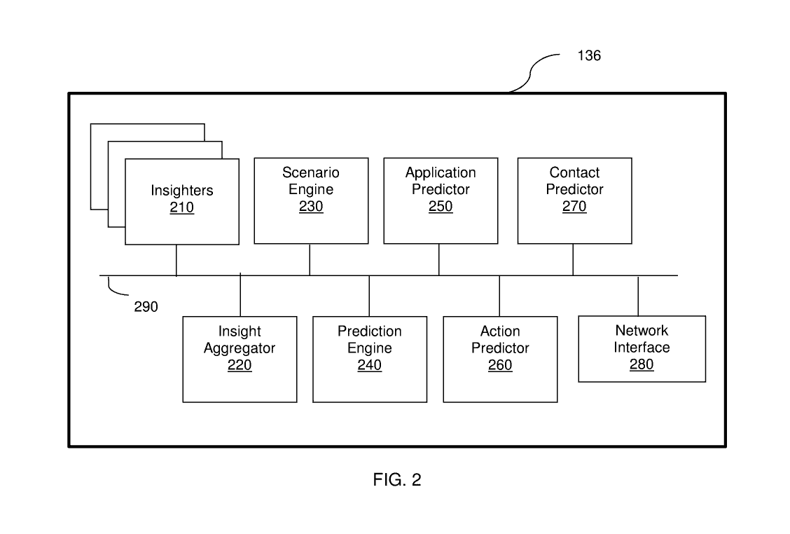

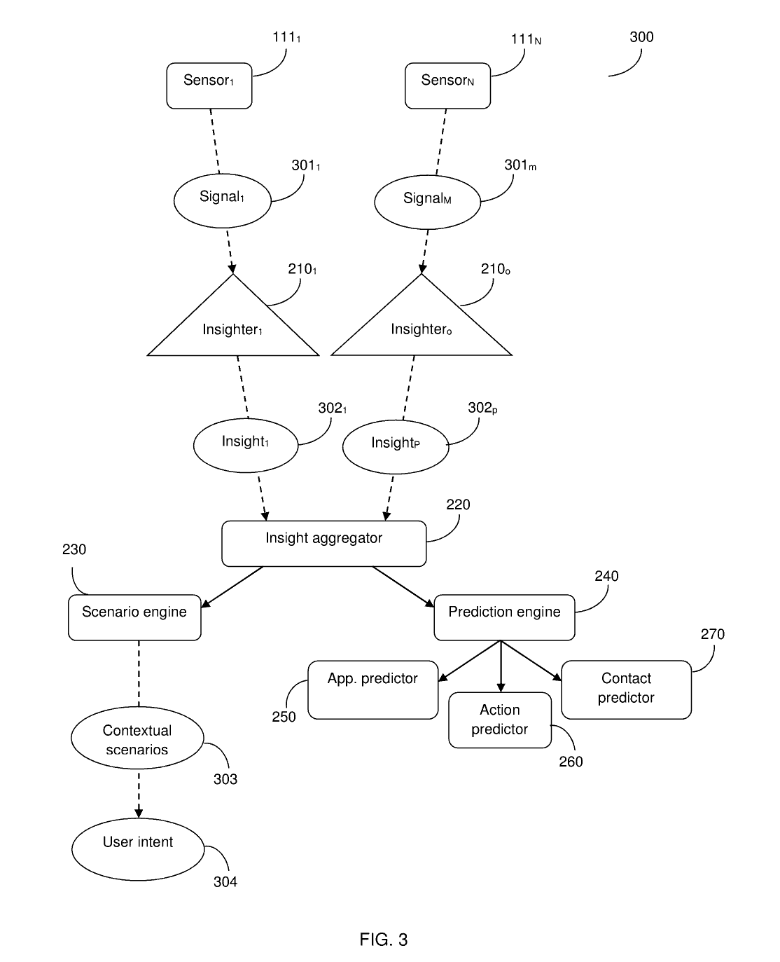

In an embodiment, the intent detector 136 includes a plurality of engines (not shown in FIG. 1), where each engine is configured to analyze collected variables with respect to one or more topics of interest to the engine. Various example engines utilized by an intent detector are described further herein below with respect to FIGS. 2 and 3.

In an example embodiment, the server 130 is configured to receive a query from the user device 110 and to send the query to one or more of the data sources 140 based on the determined user intent. For example, it a query term is “Hector Berlioz,” then it is most likely that the best answers will come from data sources capable of handling classical music queries. In a further embodiment, the server 130 is configured to determine which of the data sources 140 to send the query based on, for example, registration of the data sources 140 to certain categories such as “music” or “carpentry tools,” registration of the data sources 140 to certain keywords, and the like. Sending queries to appropriate resources based on user intent is described further in U.S. Pat. No. 9,323,844, assigned to the common assignee, which is hereby incorporated by reference.

In an embodiment, to identify a confidence that the determined user intent is accurate, the server 130 is configured to verify the user intent. To this end, the server 130 requests the intent detector 136 to determine a user intent based on one or more of the collected variables. Either or both of the server 130 and the intent detector 136 may be configured to store the collected variables in, e.g., the database 150.

In an example embodiment, based on the user intent, the server 130 is configured to generate one or more contextual assumptions indicating future behavior of the user given the current user intent. In a further embodiment, the server 130 generates the contextual assumptions via the intent detector 136. The contextual assumptions may include, but are not limited to, applications that are likely to be launched, actions that are likely to be taken, contacts that are likely to be communicated with, sensor readings that are likely to be detected, and other circumstances that are likely to be identified given a current user intent.

Each contextual assumption may be or may include one or more expected variables representing, e.g., an action, a sensor reading, a user interaction, a numerical value, text, and the like. The expected variables indicate variables that are likely to be collected if the user acts in accordance with the determined user intent. As a non-limiting example, if the user intent is determined to be that the user is going jogging, the expected variables may include sensor readings indicating movement from an accelerometer and GPS. The server 130 may be configured to store the expected variables in, e.g., the database 150.

In yet a further embodiment, the expected variables may be determined further based on common behavior patterns of the user of the user device 110. Each of the common behavior patterns may be, e.g., stored in the database 150 or identified by the intent detector 136. As a non-limiting example, when the user intent is determined to be that the user is going jogging and identified common behavior patterns for the user include jogging on a particular route, the predicted future behavior may be movement of the user device 110 along that route, and the expected variables may include sensor readings from an accelerometer indicating movement, from a GPS indicating that the user device 110 is moving generally along the route, and the like.

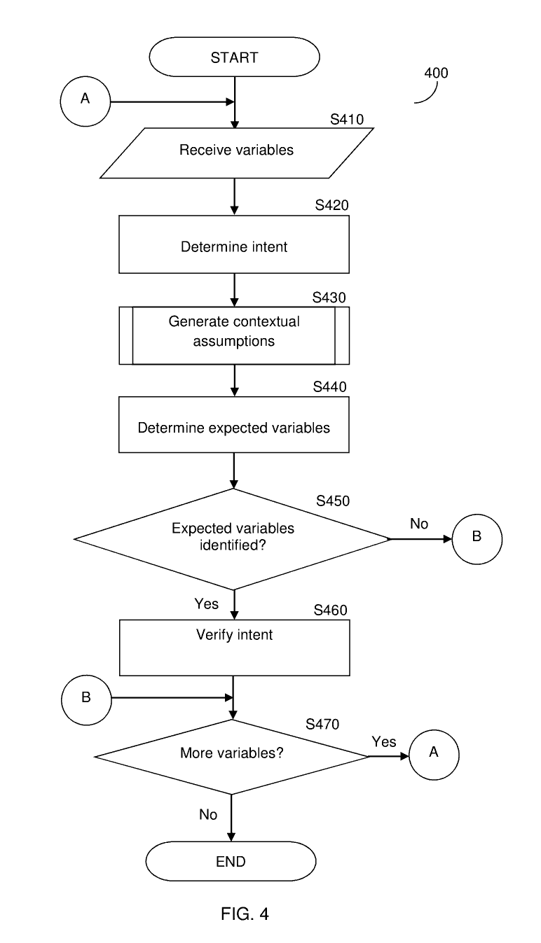

In an embodiment, the server 130 is configured to utilize the expected variables to validate the contextual assumptions. To this end, the server 130 is configured to identify variables related to the user device 110 and to determine, based on the variables, whether the expected variables have been identified. In an embodiment, if the expected variables have been identified, the server 130 may be configured to determine that the contextual assumptions are valid. In a further embodiment, the expected variables are only considered identified if they occur, e.g., before a predetermined time threshold, before occurrence of another particular event, and so on. If the contextual assumptions are valid, the server 130 may be configured to verify the user intent. Verification of user intent is described further herein below with respect to FIG. 4.

It should be noted that the server 130 typically includes a processing system (PS) 132 coupled to a memory (mem) 134. The processing system 132 may comprise or be a component of a processor (not shown) or an array of processors coupled to the memory 134. The memory 134 contains instructions that can be executed by the processing system 132. The instructions, when executed by the processing system 132, cause the processing system 132 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system 132 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

It should be further noted that a single user device 110 is shown in FIG. 1 merely for simplicity purposes and without limitation on the disclosed embodiments. Multiple user devices may be communicatively connected to the server 130 over the network 120 without departing from the scope of the disclosure.

It should also be noted that the intent detector 136 is shown as being included in the server 130 merely for simplicity purposes and without limitation on the disclosed embodiments. The intent detector 136 may be separate from and communicatively connected to the server 130 (e.g., over the network 120) without departing from the scope of the disclosure. In some embodiments, the functionality of the intent detector 136 may be integrated by the agent 115. Thus, in such embodiments, the user is determined to detect the user intent.

It should be understood that the embodiments disclosed herein are not limited to the specific architecture illustrated in FIG. 1, and other architectures may be equally used without departing from the scope of the disclosed embodiments. Specifically, the server 130 may reside in a cloud computing platform, a datacenter, and the like. Moreover, in an embodiment, there may be a plurality of servers operating as described hereinabove and configured to either have one as a standby, to share the load between them, or to split the functions between them.

FIG. 2 is an example schematic diagram illustrating the intent detector 136 according to an embodiment. In an embodiment, the intent detector 136 includes a plurality of insighters 210, an insight aggregator 220, a contextual scenario engine 230, a prediction engine 240, an application predictor 250, an action predictor 260, a contact predictor 270, and an interface 280. In an embodiment, the various engines may be connected via a bus 290.

The insighters 210 are configured to generate insights based on signals (e.g., signals collected by the sensors 111), variables (e.g., variables collected by the user device 110 or the agent 115), or a combination thereof. Each insight relates to one of the variables or signals. The insighters 210 may be further configured to classify the signals and variables and to generate conclusions based thereon. In a further embodiment, the insighters 210 may be further configured to generate weighted factors indicating a confidence level in each insight, i.e., a likelihood that the insight is correct.

The insight aggregator 220 may be configured to differentiate among the insights based on, e.g., commonality of the signals and variables. In a further embodiment, the insight aggregator 220 is configured to identify common behavior patterns based on the differentiation.

The contextual scenario engine 230 is configured to generate contextual scenarios based on the insights generated by the insighters 210 or differentiated by the insight aggregator 220. In an embodiment, the contextual scenarios may be generated using a database (e.g., the database 150) having a plurality of contexts and corresponding insights. Each context represents a current state of the user as demonstrated via the insights. For example, based on variables indicating that a user has searched for cake recipes and has set a timer function, a contextual scenario indicating that the user is baking may be generated. In a further embodiment, the contextual scenario engine 230 is configured to determine a user intent based on the generated contextual scenarios.

The prediction engine 240 is configured to determine predicted future behavior of the user device 110. The predicted behavior may include, but is not limited to, environmental parameters, actions, communications with particular contacts, launching of particular applications, and the like.

In an embodiment, the prediction engine 240 may include or be communicatively connected to an application program predictor (app. predictor) 250, an actions predictor 260, and a contact predictor 270. The application program predictor 250 is configured to, e.g., identify applications that are likely to be launched on the user device 110. The actions predictor 260 is configured to, e.g., identify actions that a user is likely to perform via the user device 110. The contact predictor 270 is configured to, e.g., identify data related to contacts that the user will likely communicate with.

The interface 280 allows the intent detector 136 to communicate with, e.g., the user device 110, the server 130, and the network 120 to, e.g., receive variables and to send determined user intents.

It should be noted that the intent detector 136 described herein with respect to FIG. 2 is merely an example and is not limited to the particular architecture disclosed herein. An intent detector having more, less, or different engines or otherwise having different architecture may be utilized without departing from the scope of the disclosure.

It should be further noted that the prediction engine 240 is shown in FIG. 2 as being separate from the application predictor 250, the action predictor 260, and the contact predictor 270 merely for simplicity purposes and without limitation on the disclosed embodiments. The prediction engine 240 may include the application predictor 250, the action predictor 260, and the contact predictor 270 without departing from the scope of the disclosure.

In certain configurations the plurality of insighters 210, the insight aggregator 220, the contextual scenario engine 230, the prediction engine 240, the application predictor 250, the action predictor 260, the contact predictor 270, and the interface 280 may be realized as hardware component or components. Such a hardware component includes general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

FIG. 3 depicts an example flow diagram 300 illustrating an operation of the intent detector 136 based on sensor signals according to an embodiment. In an embodiment, the intent detector 136 includes the plurality of insighters 210₁ through 210_{O}, the insight aggregator 220, the scenario engine 230, the prediction engine 240, the application predictor 250, the action predictor 260, and the contact predictor 270.

The operation of the intent detector 136 starts when one or more of a plurality of sensors 111₁ through 111_{N} of the user device 110 collects a plurality of signals 301₁ through 301_{M} (hereinafter referred to individually as a signal 301 and collectively as signals 301, merely for simplicity purposes). The signals 301 are received by the server 130. Based on the collected signals 301, the plurality of insighters 210₁ through 210_{O} are configured to generate a plurality of insights 302₁ through 302_{P} (hereinafter referred to individually as an insight 302 or collectively as insights 302, merely for simplicity purposes). Each insight 302 relates to one of the collected signals 301.

The insight aggregator 220 is configured to differentiate between the plurality of insights 302 generated by the insighters 210. The differentiation may include, but is not limited to, identifying common behavior patterns as opposed to frequent uses, thereby increasing the efficiency of the insights generation.

According to the disclosed embodiments, a common behavior pattern may be identified when, for example, a particular signal is received at approximately regular intervals. For example, a common behavior pattern may be identified when a GPS signal indicates that a user is at a particular location between 8 A.M. and 10 AM every business day (Monday through Friday). Such a GPS signal may not be identified as a common behavior pattern when the signal is determined at sporadic intervals. For example, a user occupation of the same location on a Monday morning one week, a Friday afternoon the next week, and a Saturday evening on a third week may not be identified as a common behavior pattern. As another example, a common behavior pattern may be identified when an accelerometer signal indicates that a user is moving at 10 miles per hour every Saturday morning. As yet another example, a common behavior pattern may be identified when a user calls a particular contact in the evening on the first day of each month.

The differentiated insights 302 are sent to a contextual scenario engine 230, to a prediction engine 240, or to both. The contextual scenario engine 230 is configured to generate one or more contextual scenarios 303 associated with the insights 302. In an embodiment, the contextual scenario engine 230 may be further configured to determine a user intent 304 of a user of the user device 110 based on the generated contextual scenarios. Generating contextual scenarios and executing actions respective thereof are described further herein below with respect to FIG. 4.

The prediction engine 240 is configured to predict future behavior of the user device 110 based on the insights 302. Based on the predicted future behavior, the prediction engine 240 may be configured to generate a prediction model. The prediction model may be utilized to determine actions indicating user intents that may be taken by the user in response to particular contextual scenarios. Further, the prediction model may include a probability that a particular contextual scenario will result in a particular action. For example, if user interactions used to generate the prediction model indicate that a user launched an application for seeking drivers 3 out of the last 4 Saturday nights, an action of launching the driver application may be associated with a contextual scenario for Saturday nights and with a 75% probability that the user intends to launch the application on a given Saturday night.

The prediction engine 240 may include or may be communicatively connected to an application program predictor (app. predictor) 250 for identifying application programs that are likely to be launched on the user device. The prediction engine 240 may further include an actions predictor 260 for identifying actions that a user is likely to perform on the user device 110. The prediction engine 240 may further include a contact predictor 270 used to identify data related to persons that a user of the user device 110 is likely to contact.

It should be noted that FIG. 3 is described with respect to received signals merely for simplicity purposes and without limitation on the disclosed embodiments. The insighters 210 may, alternatively or collectively, generate insights based on variables (e.g., environmental variables, personal variables, queries, or a combination thereof) without departing from the scope of the disclosure.

It should be further noted that the embodiments described herein above with respect to FIGS. 1-3 are described with respect to a single user device 110 having one agent 115 merely for simplicity purposes and without limitation on the disclosed embodiments. Multiple user devices, each equipped with an agent, may be used and actions may be executed respective of contextual scenarios for the user of each user device without departing from the scope of the disclosure.

FIG. 4 is an example flowchart 400 illustrating a method for verifying a user intent according to an embodiment. In an embodiment, the method may be performed by the server 130.

At S410, at least one variable is received. A variable may be received from a sensor installed in the user device, a query input by a user, and the like. The variables may include, but are not limited to, queries, personal variables, environmental variables, combinations thereof, and the like. As a non-limiting example, a variable may include a query of how to get from a first location coordinate to a second location coordinate sent to a navigation application on the user device.

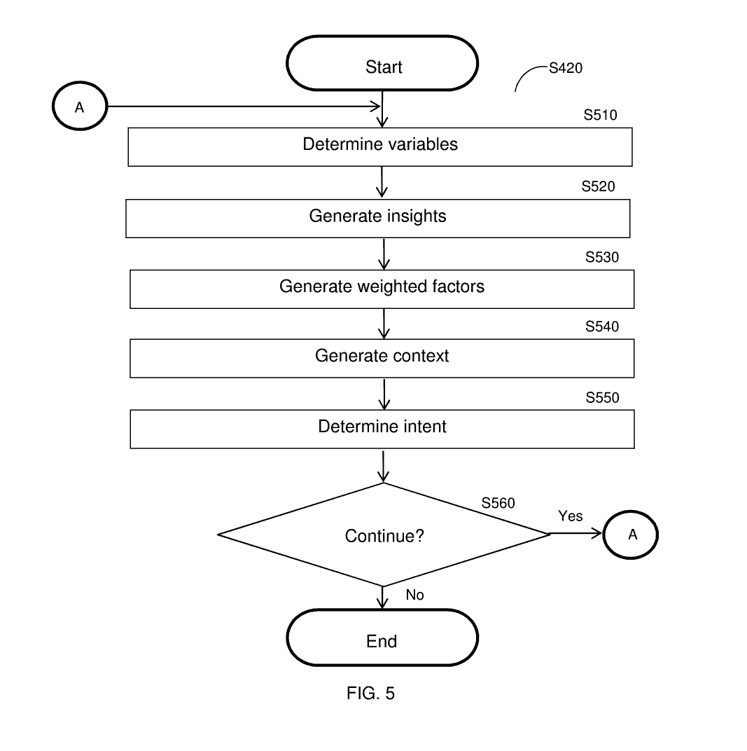

At S420, a user intent is determined based on the received variable or variables. In an embodiment, determining the user intent may include generating one or more insights related to the variables and generating a context based on the insights. The user intent may be determined based on the context. In an example embodiment, the determination of the user intent may be performed by the user intent. Determining user intents is described further herein below with respect to FIG. 5.

At S430, contextual assumptions are determined based on the user intent. The contextual assumptions represent circumstances that will occur if the user acts in accordance with the determined user intent. The contextual assumptions may be expressed as activities indicating, but not limited to, particular actions with respect to the user device, uses of particular applications of the user device, communicating with particular contacts, particular sensor readings, and the like. For example, a contextual assumption may be motion of the user device. In another embodiment, the determination of the contextual assumptions may be further based on predicted future behavior of the user device determined based on the variables. The predicted future behavior may be determined by, e.g., the intent detector.

As an example of determination contextual assumptions, if the user intent is “traveling from a first coordinate to a second coordinate,” a contextual assumption that the user of the user device will arrive at the second coordinate may be determined. A further contextual assumption that the user will arrive at the second coordinate within a particular time period (e.g., an estimated time of the trip based on the distance) may also be determined. Determining contextual assumptions based on user intent is described further herein below with respect to FIG. 3.

At S440, expected variables are determined based on the contextual assumptions. The expected variables are variables that would be detected if the user acts in accordance with the determined user intent. The expected variables may include or represent, but are not limited to, sensor reading values, times, dates, user inputs (e.g., text, numerical values, etc.), detection of an execution of a particular application, detection of a communication with a particular contact, and the like. As an example, if the contextual assumptions indicate that the user will be at a yoga class at between 8 AM and 9 AM, the expected variables may include GPS coordinates associated with a yoga studio at a time between 8 AM and 9 AM.

At S450, it is checked whether the expected variables have been identified and, if so, execution continues with S460; otherwise, execution continues with S470. In an embodiment, checking whether the expected variables have been identified may include monitoring collections of variables related to the user device and determining, based on the monitoring, whether any of the monitored variables match the expected variables. The matching may be further based on a predetermined threshold. As an example, if the expected variables indicate that the user is attending a race at a particular park identified by its GPS coordinates, GPS coordinates that differ from the park's GPS coordinates below a predefined threshold (e.g., within 100 feet of the park) may be considered to match the expected variables. The threshold utilized may further depend on the type and values of the expected variables.

In another embodiment, checking whether the expected variables have been identified may only be performed for a limited time. In a further embodiment, the limited time may be based on, but not limited to, a predetermined time period (e.g., within 10 minutes, 1 hour, or 1 day of determining the user intent), before occurrence of a predefined event (e.g., detection of a different user intent or detection of a particular user intent), and the like. If the expected variables are not identified during the limited time, it may be determined that the expected variables have not been identified.

At S460, upon identifying the expected variables, the contextual assumptions are validated and the user intent is verified. In an embodiment, S460 may further include generating a notification regarding the verified user intent. The notification may be sent to, e.g., a device or server of an advertiser seeking to provide relevant advertisements based on the user intent.

At S470, it is determined whether additional variables have been received and, if so, execution continues with S410; otherwise, execution terminates.

As a non-limiting example, a query “how to get from 12 Main Street to 34 Washington Street” may be provided by a user of a user device via a navigation application installed on the user device. Based on the query variable, a user intent of “traveling from 12 Main Street to 34 Washington Street” is determined. Contextual assumptions including motion of the user device from 12 Main Street to 34 Washington Street are generated based on the user intent. Corresponding expected variables are determined to include GPS coordinates along one of the routes between 12 Main Street and 34 Washington Street. When the user subsequently begins moving along a route to 34 Washington Street, GPS signals for coordinates along the route are detected. Accordingly, it is determined that the expected variables have been identified, and the user intent is verified.

FIG. 5 depicts an example flowchart S420 illustrating a method for contextually determining user intent based on use of a user device (e.g., the user device 110) according to an embodiment. In an embodiment, the method may be performed by an intent detector (e.g., the intent detector 136) or by a server (e.g., the server 130). In another embodiment, the method performed by an agent (e.g., agent 115) operable in the user device.

At S510, variables related to a user device are determined. The variables may include, but are not limited to, environmental variables, personal variables, queries, combinations thereof, and so on. In an embodiment, the determined variables may be obtained from a database or from the user device (e.g., via an agent executed by the user device). In another embodiment, the determined variables may be based on one or more signals such as, e.g., sensor signals captured by sensors associated with the user device.

At S520, one or more insights are generated based on the variables. In an embodiment, S520 may further include generating a conclusion based on the insights, and so on. In a further embodiment, the conclusions may be generated based on past user interactions, user behavior patterns, or a combination thereof.

At optional S530, a weighted factor is generated respective of each insight. Each weighted factor indicates the level of confidence in each insight, i.e., the likelihood that the insight is accurate for the user's current intent. The weighted factors may be adapted over time. To this end, the weighted factors may be based on, for example, previous user interactions with the user device. Specifically, the weighted factors may indicate a probability, based on previous user interactions, that a particular insight is associated with the determined variables.

At S540, a context is generated respective of the insights and their respective weighted factors. The generated context may include, but is not limited to, one or more contextual scenarios. Generating contexts may be performed, for example, by matching the insights to insights associated with contextual scenarios stored in a contextual database (e.g., the contextual database 140). The generated context may be based on the contextual scenarios associated with each matching insight. In an embodiment, the matching may further include matching textual descriptions of the insights.

At S550, based on the generated context, a user intent is determined. The user intent may be determined based on a prediction model. In an embodiment, the prediction model may have been generated as described further herein above with respect to FIG. 3.

At S560, it is checked whether additional variables have been determined and, if so, execution continues with S510; otherwise, execution terminates. The checks for additional variables may be performed, e.g., continuously, at regular intervals, or upon determination that one or more signals have changed.

As a non-limiting example, a GPS signal is used to determine environmental variables indicating that the user is at the address of a supermarket on a Saturday morning. Based on the variables, an insight illustrating that the variable is related to a location and a conclusion that variables are in accordance with the user's typical behavior pattern is generated. The insight is further matched to insights stored in a contextual database to identify contextual scenarios associated thereto and a context is generated based on the contextual scenarios. The context indicates that the user intent is weekly grocery shopping.

It should be noted that the disclosed embodiments for determining the user intents, the contextual assumptions, and verifying the user intents can be performed exclusively by a user device (e.g., device 110) or by the server (e.g., server 130) using inputs received from the user.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for contextual verification of a user intent, comprising:
determining, based on at least one variable related to a user device, a user intent;
determining, based on the user intent, at least one contextual assumption;
determining, based on the at least one contextual assumption, at least one expected variable;
determining whether the at least one expected variable has been identified with respect to the user device; and
determining the user intent as verified, when the at least one expected variable has been identified.

2. The method of claim 1, wherein each of the at least one variable is any of: a personal variable, an environmental variable, and a query.

3. The method of claim 1, wherein each of the at least one contextual assumption is any of: a particular action, an execution of a particular application, a communication with a particular contact, and a particular sensor reading.

4. The method of claim 3, wherein each of the at least one expected variable is any of: a sensor reading value, a time, a date, a particular user input, a particular portion of a user input, detection of an execution of a particular application, and detection of a communication with a particular contact.

5. The method of claim 1, further comprising:
identifying at least one subsequent variable related to the user device; and
matching the at least one subsequent variable to the at least one expected variable, wherein the at least one expected variable is identified if the at least one expected variable matches the at least one subsequent variable above a predetermined threshold.

6. The method of claim 1, wherein the at least one variable related to the user device is received from at least one sensor communicatively connected to the user device

7. The method of claim 1, further comprising:
generating at least one insight based on the at least one variable related to the user device; and
generating a context for the user device based on the at least one insight, wherein the user intent is determined based on the generated context.

8. The method of claim 6, wherein generating the at least one insight further comprises:
classifying the at least one variable related to the user device; and
generating a conclusion based on the classification.

9. The method of claim 1, wherein the user intent is determined based on a prediction model.

10. A non-transitory computer readable medium having stored thereon instructions for causing one or more processing units to execute the method according to claim 1.

11. A server for context verification of a user intent, comprising:
a processing system; and
a memory, the memory containing instructions that, when executed by the processing system, configure the server to:
determining, based on at least one variable related to a user device, a user intent;
determining, based on the user intent, at least one contextual assumption;
determining, based on the at least one contextual assumption, at least one expected variable;
determining whether the at least one expected variable has been identified with respect to the user device; and
determining the user intent as verified, when the at least one expected variable has been identified.

12. The server of claim 11, wherein each of the at least one variable is any of: a personal variable, an environmental variable, and a query.

13. The server of claim 11, wherein each of the at least one contextual assumption is any of: a particular action, an execution of a particular application, a communication with a particular contact, and a particular sensor reading.

14. The server of claim 13, wherein each of the at least one expected variable is any of: a sensor reading value, a time, a date, a particular user input, a particular portion of a user input, detection of an execution of a particular application, and detection of a communication with a particular contact.

15. The server of claim 11, wherein the server is further configured to:
identify at least one subsequent variable related to the user device; and
match the at least one subsequent variable to the at least one expected variable, wherein the at least one expected variable is identified if the at least one expected variable matches the at least one subsequent variable above a predetermined threshold.

16. The server of claim 11, wherein the at least one variable related to the user device is received from at least one sensor communicatively connected to the user device

17. The server of claim 11, wherein the server is further configured to:
generate at least one insight based on the at least one variable related to the user device; and
generate a context for the user device based on the at least one insight, wherein the user intent is determined based on the generated context.

18. The server of claim 16, wherein the server is further configured to:
classify the at least one variable related to the user device; and
generate a conclusion based on the classification.

19. The server of claim 11, wherein the user intent is determined based on a prediction model.
